(19) United States
(12) Patent Application Publication
(10) Pub. No.: US 2016/0288631 A1
(43) Pub. Date: Oct. 6, 2016

(54) DUAL DRIVE SUNROOF TRANSMISSION ASSEMBLY

(71) Applicant: GM GLOBAL TECHNOLOGY OPERATIONS LLC, Detroit, MI (US)

(72) Inventors: Kevin K. Parkila, Royal Oak, MI (US); Procopio Vitale, Macomb Township, MI (US); Samer J. Mona, West Bloomfield, MI (US)

(73) Assignee: GM GLOBAL TECHNOLOGY OPERATIONS LLC, Detroit, MI (US)

(21) Appl. No.: 14/800,146

(22) Filed: Jul. 15, 2015

Related U.S. Application Data
(60) Provisional application No. 62/140,817, filed on Mar. 31, 2015.

(51) Int. Cl. B60J 7/057; B60J 7/043; F16H 19/06

(52) U.S. Cl. CPC B60J 7/0573; F16H 19/06; B60J 7/043

(57) ABSTRACT

A sunroof transmission assembly includes a housing, a first gear set supported by the housing, and a first motor attached to the housing and disposed in meshing engagement with the first gear set. A first flexible cable drive is disposed in meshing engagement with a first output gear of the first gear set, and is operable to move a first sunroof component in response to a rotational output from the first motor. A second gear set is supported by the housing. A second motor is attached to the housing, and is disposed in meshing engagement with the second gear set. A second flexible cable drive is disposed in meshing engagement with a second output gear of the second gear set, and is operable to move a second sunroof component in response to a rotational output from the second motor.

### CROSS-REFERENCE TO RELATED APPLICATIONS

This application claims the benefit of U.S. Provisional Patent Application Serial No. 62/140,817, filed on Mar. 31, 2015, the disclosure of which is hereby incorporated by reference.

### TECHNICAL FIELD

The disclosure generally relates to a sunroof transmission assembly for a vehicle.

### BACKGROUND

Sunroof assemblies for a vehicle often include a first movable component, such as a movable glass panel component, and a second movable component, such as a movable shade component. The movable glass component and the movable shade component are often actuated by a respective transmission assembly. Each transmission assembly includes a motor that is coupled to a flexible cable drive through a gear set. Rotational output from the motor drives the flexible cable drive, which in turn moves its respective movable component. Each of the respective transmission assemblies for the movable components, as well as their respective flexible cable drives, are located above a headliner, between the headliner and a roof of the vehicle's body.

### SUMMARY

A sunroof transmission assembly for a vehicle is provided. The sunroof transmission assembly includes a housing, and a first gear set that is supported by the housing. A first motor is attached to the housing, and includes a first output member in meshing engagement with the first gear set. A second gear set is supported by the housing. A second motor is attached to the housing, and includes a second output member in meshing engagement with the second gear set.

A vehicle is also provided. The vehicle includes a body having a roof that defines an opening. A sunroof assembly is attached to the roof of the body, adjacent to the opening. The sunroof assembly includes a first movable component, a second movable component, and a sunroof transmission assembly. The sunroof transmission assembly is coupled to each of the first movable component and the second movable component, and is operable to move each of the first movable component and the second movable component. The sunroof transmission assembly includes a housing. A first gear set is supported by the housing, and includes a first output gear. A first motor is attached to the housing, and includes a first output member in meshing engagement with the first gear set. A first flexible cable drive is disposed in meshing engagement with the first output gear of the first gear set. The first flexible cable drive is operable to move the first sunroof component in response to a rotational output from the first motor. A second gear set is supported by the housing, and includes a second output gear. A second motor is attached to the housing, and includes a second output member in meshing engagement with the second gear set. A second flexible cable drive is disposed in meshing engagement with the second output gear of the second gear set. The second flexible cable drive is operable to move the second sunroof component in response to a rotational output from the second motor.

Accordingly, the housing of the sunroof transmission assembly supports both the first motor and the first gear set, as well as the second motor and the second gear set. By combining the first and second motors and the first and second gear sets into one assembly, supported by the single housing, the lateral and for/aft packaging requirements of the sunroof transmission assembly are greatly reduced, allowing the sunroof transmission assembly to be positioned over an upper center console in the headliner. By positioning the sunroof transmission assembly over the upper center console of the headliner, the portions of the headliner disposed over the driver and passenger side seating areas may be held closely to the roof of the body, thereby providing additional head space for passengers.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a vehicle, showing a sunroof assembly.

FIG. 2 is a schematic perspective view of a headliner of the vehicle and a sunroof transmission assembly of the sunroof assembly.

FIG. 3 is a schematic plan view of the sunroof transmission assembly.

FIG. 4 if a schematic plan view of the sunroof transmission assembly.

FIG. 5 is a schematic perspective view of the headliner of the vehicle and an alternative embodiment of the sunroof transmission assembly.

FIG. 6 is a schematic plan view of the alternative embodiment of the sunroof transmission assembly.

FIG. 7 is a schematic cross sectional view taken along cut line 7-7 shown in FIG. 3.

FIG. 8 is a schematic cross sectional view taken along cut line 8-8 shown in FIG. 3.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

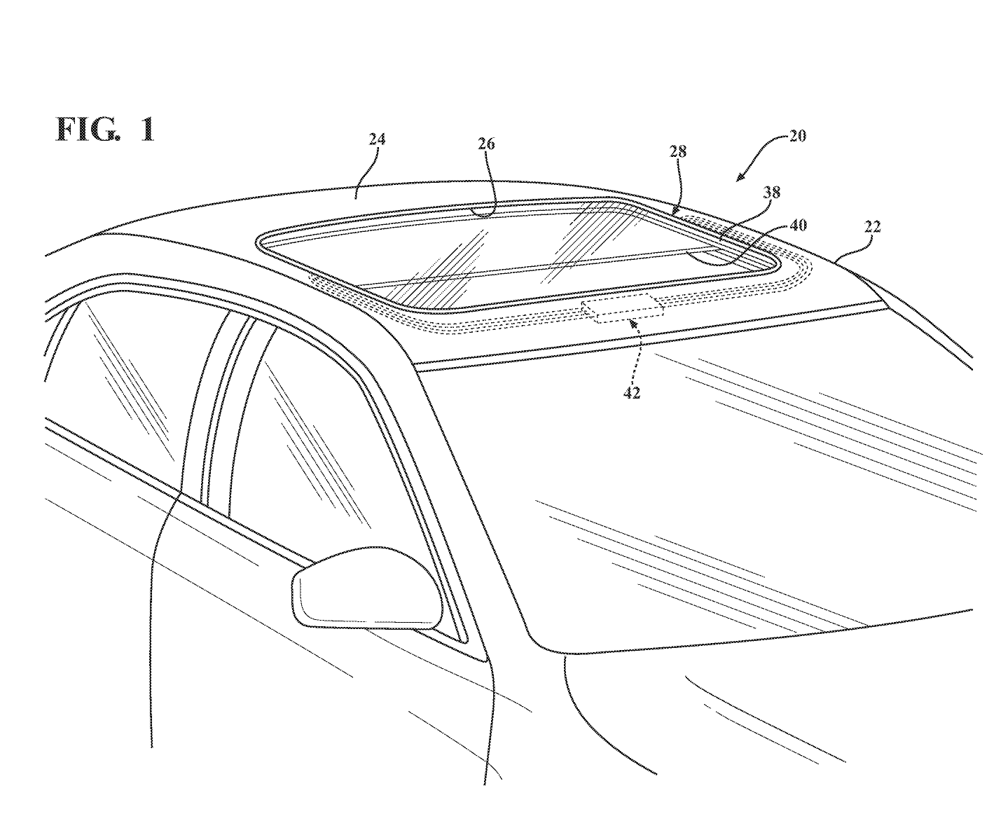

Referring to the Figures, wherein like numerals indicate like parts throughout the several views, a vehicle is generally shown at 20 in FIG. 1. Referring to FIG. 1, the vehicle 20 includes a body 22 having a roof 24. The roof 24 defines an opening 26, and includes a sunroof assembly 28 attached to the roof 24. The vehicle 20 may be configured as an automobile, such as but not limited to a sedan, SUV, truck, etc., or may be configured as some other type of vehicle 20, such as a boat.

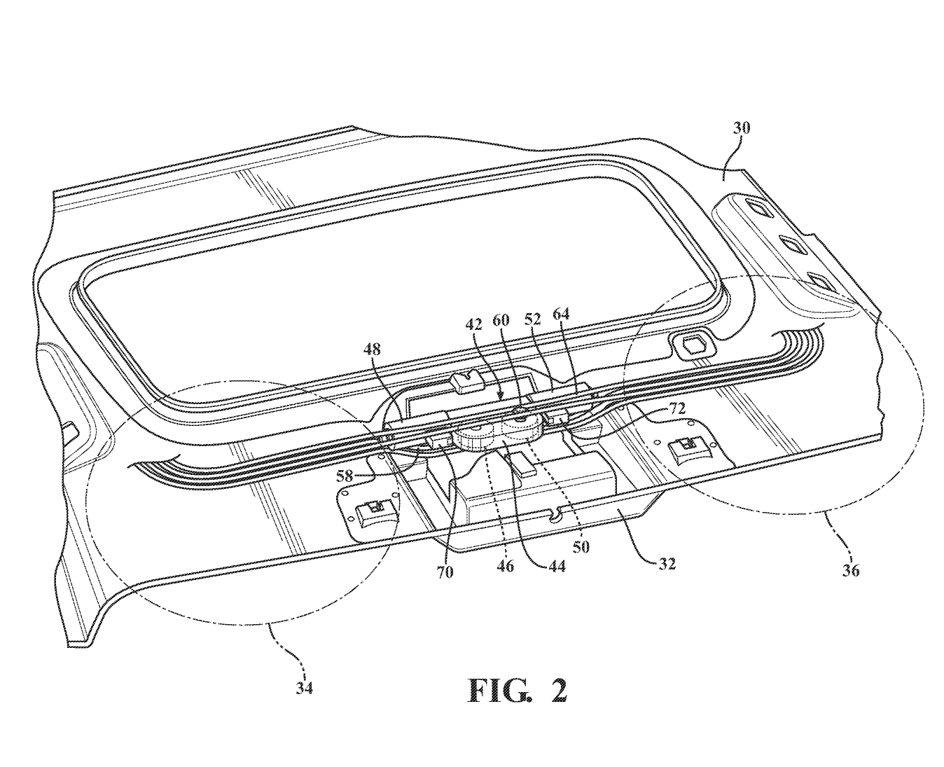

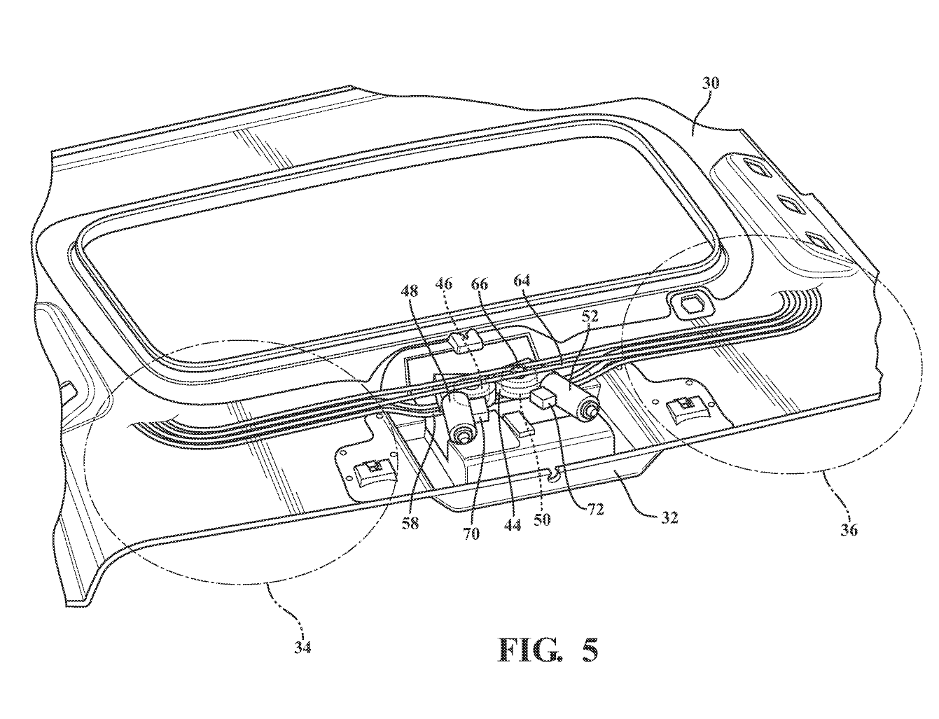

Referring to FIGS. 2 and 5, the vehicle 20 includes a headliner 30, which is disposed adjacent the roof 24 (not shown in FIGS. 2 and 5), within an interior space of the vehicle 20. The headliner 30 includes an upper center console 32 that is laterally disposed between a first passenger area 34 and a second passenger area 36. The opening 26 is preferably disposed rearward of the upper center console 32. However, it should be appreciated that the opening 26 may alternatively be disposed forward of the upper center console 32.

The sunroof assembly 28 is at least partially disposed between the roof 24 and the headliner 30. Referring to FIG. 1, the sunroof assembly 28 is attached to the roof 24 of the body 22, adjacent to the opening 26. Referring also to FIGS. 2 and 5, the sunroof assembly 28 includes a first movable component 38 and a second movable component 40. The first movable component 38 may be defined as a glass panel, which is movable along a longitudinal axis of the body 22, between a closed position and an open position. When disposed in the closed position, the glass panel covers the opening 26 in the roof 24, to block access through the opening 26, while allowing light to pass through. The second movable component 40 may be defined as a shade, which is movable along the longitudinal axis of the body 22, between a closed position and an open position. When disposed in the closed position, the shade covers the glass panel from within the interior of the vehicle 20, so that passengers may not see the glass panel and so that light may not pass through the glass panel into the interior of the vehicle 20. While the first movable component 38 and the second movable component 40 are referred to herein as the glass panel and the shade respectively, it should be appreciated that the first movable component 38 and the second movable component 40 may be defined as other components of the sunroof assembly 28. For example, the sunroof assembly 28 may include two glass panels that are each independently movable relative to each other. Therefore, the first movable component 38 may be defined as a first glass panel, and the second movable component 40 may be defined as a second glass panel. Other configuration of the sunroof assembly 28 may include other movable components that may be defined as the first movable component 38 and/or the second movable component 40.

The first movable component 38 and the second movable component 40 may be moveably attached to the roof 24 in any suitable manner known to those skilled in the art. For example, the first movable component 38 and the second movable component 40 may each be supported in respective parallel tracks, on which the first movable component 38 and the second movable component 40 slide. The specific manner in which the first movable component 38 and the second movable component 40 are moveably supported relative to the roof 24 is not pertinent to the teachings of the disclosure, and are therefore not described in detail herein.

As shown in FIGS. 1, 2, and 5, the sunroof assembly 28 further includes a sunroof transmission assembly 42 that is coupled to each of the first movable component 38 and the second movable component 40. The sunroof transmission assembly 42 is operable to move each of the first movable component 38 and the second movable component 40, along the longitudinal axis of the vehicle 20, between their respective closed and open positions.

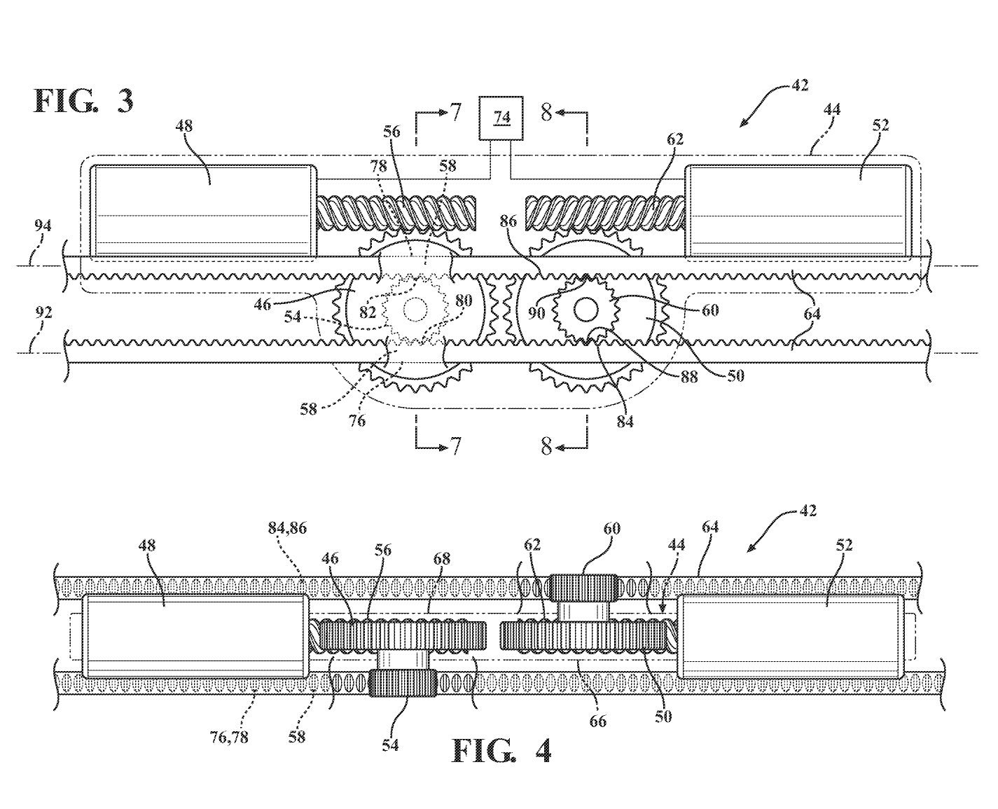

Referring to FIGS. 3, 4, and 6, the sunroof transmission assembly 42 includes a housing 44. The housing 44 is attached to the roof 24, and supports a first gear set 46, a first motor 48, a second gear set 50, and a second motor 52. The housing 44 includes a single structure, which supports both the first gear set 46 and the second gear set 50, and both the first motor 48 and the second motor 52. The first motor 48 and the first gear set 46 operate independently of the second motor 52 and the second gear set 50. The first motor 48 and the second motor 52 are independently operable relative to each other such that the first gear set 46 may be driven while the second gear set 50 remains stationary, the second gear set 50 may be driven while the first gear set 46 remains stationary, or so that the first gear set 46 and the second gear set 50 can be driven simultaneously.

Referring to FIGS. 3 and 4, the first gear set 46 includes a first output gear 54. The first motor 48 is attached to the housing 44 and includes a first output member 56. Preferably, the first motor 48 includes an electric motor. However, it should be appreciated that the first motor 48 may include some other type of motor capable of producing a rotational output. The first output member 56 of the first motor 48 is disposed in meshing engagement with the first output gear 54 of the first gear set 46. The first motor 48 generates a rotational output. Operation of the first motor 48 rotates the first output member 56 to provide the rotational output. The first output member 56 may be defined as a worm gear, i.e., a cylinder presenting a screw thread. Because the first output member 56 is disposed in meshing engagement with the first gear set 46, rotation of the first output member 56 causes the first gear set 46 to rotate. The first gear set 46 may include any desirable configuration and/or arrangement of gears, which drive the first output gear 54. For example, the first gear set 46 may include, but is not limited to, a planetary gear set, or some other type of gearing arrangement capable of transmitting torque and controlling rotational speed and of the first output gear 54. Rotation of the first output member 56 of the first motor 48 causes the first output gear 54 to rotate.

The sunroof transmission assembly 42 further includes a first flexible cable drive 58 that is disposed in meshing engagement with the first output gear 54 of the first gear set 46. The first flexible cable drive 58 is coupled to and operable to move the first movable component 38. The first flexible cable drive 58 may be considered a non-rotating worm gear, including an endless loop comprising a cylinder presenting screw threads. Rotation of the first output gear 54 drives or moves the first flexible cable drive 58, causing the first flexible cable drive 58 to move along a path defining an endless loop. Movement of the first flexible cable drive 58 moves the first movable component 38, as is known in the art.

Referring to FIGS. 3 and 4, the second gear set 50 includes a second output gear 60. The second motor 52 is attached to the housing 44 and includes a second output member 62. Preferably, the second motor 52 includes an electric motor. However, it should be appreciated that the second motor 52 may include some other type of motor capable of producing a rotational output. The second output member 62 of the second motor 52 is disposed in meshing engagement with the second output gear 60 of the second gear set 50. The second motor 52 generates a rotational output. Operation of the second motor 52 rotates the second output member 62 to provide the rotational output. The second output member 62 may be defined as a worm gear, i.e., a cylinder presenting a screw thread. Because the second output member 62 is disposed in meshing engagement with the second gear set 50, rotation of the second output member 62 causes the second gear set 50 to rotate. The second gear set 50 may include any desirable configuration and/or arrangement of gears, which drive the second output gear 60. For example, the second gear set 50 may include, but is not limited to, a planetary gear set, or some other type of gearing arrangement capable of transmitting torque and controlling rotational speed and of the second output gear 60. Rotation of the second output member 62 of the second motor 52 causes the second output gear 60 to rotate.

The sunroof transmission assembly 42 further includes a second flexible cable drive 64 that is disposed in meshing engagement with the second output gear 60 of the second gear set 50. The second flexible cable drive 64 is coupled to and operable to move the second movable component 40. The second flexible cable drive 64 may be considered a non-rotating worm gear, including an endless loop comprising a cylinder presenting screw threads. Rotation of the second output gear 60 drives or moves the second flexible cable drive 64, causing the second flexible cable drive 64 to move along a path defining an endless loop. Movement of the second flexible cable drive 64 moves the second movable component 40, as is known in the art.

Referring to FIGS. 3 and 4, the first gear set 46 and the second gear set 50 are generally disposed in a co-planar relationship relative to each other. As shown in FIG. 4, the housing 44 includes a first surface 66, and an opposing second surface 68. The first gear set 46 and the second gear set 50 are generally parallel with and disposed between the first surface 66 and the second surface 68. The first output gear 54 is disposed adjacent one of the first surface 66 and the second surface 68, and the second output gear 60 is disposed adjacent the other of the first surface 66 and the second surface 68. Accordingly, the first output gear 54 and the second output gear 60 are disposed adjacent opposing surfaces of the housing 44. As shown in FIG. 4, the first output gear 54 is disposed adjacent the lower, first surface 66, and the second output gear 60 is disposed adjacent the upper, second surface 68. However, it should be appreciated that the relative positions may be reversed, with the first output gear 54 disposed adjacent the upper second surface 68, and the second output gear 60 disposed adjacent the lower, first surface 66. Additionally, while the Figures show the first surface 66 as the lower surface, and the second surface 68 as the upper surface, it should be appreciated that the relative positions may be reversed, such that the first surface 66 is the upper surface, and the second surface 68 is the lower surface.

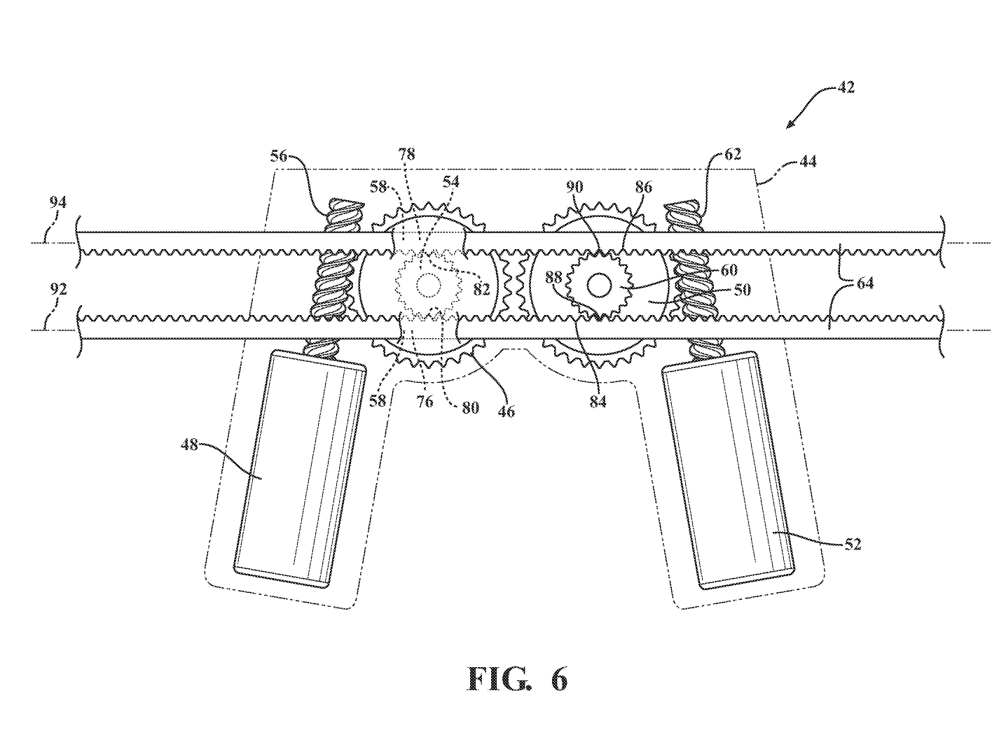

As shown in FIGS. 2 and 5, the housing 44 may include a first electrical connector 70 coupled to the first motor 48, and a second electrical connector 72 coupled to the second motor 52. Alternatively, as shown in FIGS. 3 and 6, the housing 44 need only include a single electrical connector 74, with the single electrical connector 74 disposed in electrical communication with both the first motor 48 and the second motor 52. The single electrical connector 74 may include all electrical connections necessary to control both the first motor 48 and the second motor 52, thereby reducing the required number of electrical connectors.

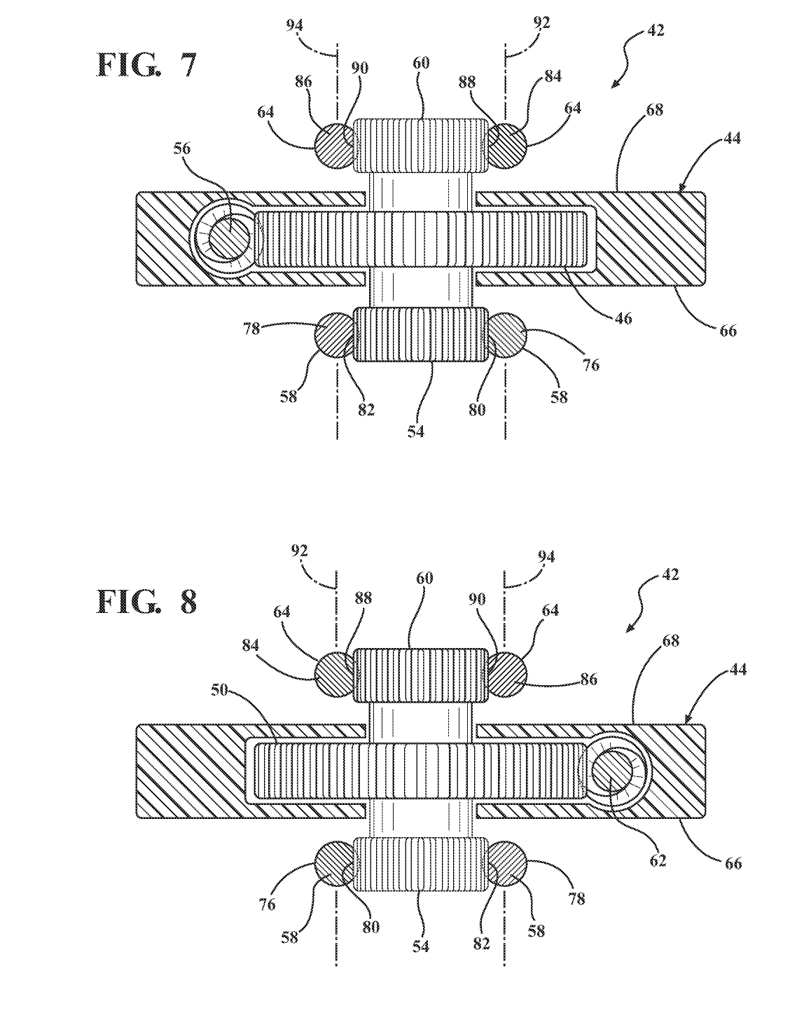

Referring to FIGS. 7 and 8, Because the first gear set 46 and the second gear set 50 are packaged so closely together in the single housing 44, the second flexible cable drive 64 is disposed and/or positioned vertically above the first flexible cable drive 58, adjacent the opposing surfaces of the housing 44. This configuration is possible because the first output gear 54 of the first gear set 46 is positioned adjacent the lower first surface 66 of the housing 44, whereas the second output gear 60 of the second gear set 50 is positioned adjacent the upper second surface 68 of the housing 44. Accordingly, the first flexible cable drive 58 is positioned adjacent the lower first surface 66 of the housing 44, whereas the second flexible cable drive 64 is positioned adjacent the upper second surface 68 of the housing 44.

Referring to FIGS. 3, 4, 7, and 8, and as noted above, the first flexible cable drive 58 includes an endless rotatable device. The first flexible cable drive 58 includes a forward loop portion 76 and a rearward loop portion 78. (The rearward loop portion 78 is directly behind the forward loop portion 76 when viewed on the page of FIG. 4.) The forward loop portion 76 of the first flexible cable drive 58 contacts the first output gear 54 in meshing engagement at a forward edge 80 of the first output gear 54. The rearward loop portion 78 of the first flexible cable drive 58 contacts the first output gear 54 in meshing engagement at a rearward edge 82 of the first output gear 54. The forward edge 80 of the first output gear 54 and the rearward edge 82 of the first output gear 54 are diametrically opposed relative to each other across a diameter of the first output gear 54.

Referring to FIGS. 3, 4, 7, and 8, and as noted above, the second flexible cable drive 64 includes an endless rotatable device. The second flexible cable drive 64 includes a forward loop portion 84 and a rearward loop portion 86. (The rearward loop portion 86 is located directly behind the forward loop portion 84 when viewed on the page of FIG. 4. Additionally, the forward loop portion 76 and the rearward loop portion 78 of the first flexible cable drive 58 are located directly underneath the forward loop portion 84 and the rearward loop portion 86 of the second flexible cable drive 64 when viewed on the page of FIG. 3.) The forward loop portion 84 of the second flexible cable drive 64 contacts the second output gear 60 in meshing engagement at a forward edge 88 of the second output gear 60. The rearward loop portion 86 of the second flexible cable drive 64 contacts the second output gear 60 in meshing engagement at a rearward edge 90 of the second output gear 60. The forward edge 88 of the second output gear 60 and the rearward edge 90 of the second output gear 60 are diametrically opposed relative to each other across a diameter of the second output gear 60.

Referring to FIGS. 7 and 8, the forward loop portion 76 of the first flexible cable drive 58 is disposed vertically above the forward loop portion 84 of the second flexible cable drive 64 on a substantially vertical plane 92, which passes through each of the forward loop portion 76 of the first flexible cable drive 58 and the forward loop portion 84 of the second flexible cable drive 64. Similarly, the rearward loop portion 78 of the first flexible cable drive 58 is disposed vertically above the rearward loop portion 86 of the second flexible cable drive 64 on a substantially vertical plane 94 passing through each of the rearward loop portion 78 of the first flexible cable drive 58 and the rearward loop portion 86 of the second flexible cable drive 64.

As shown in FIGS. 2 and 5, the sunroof transmission assembly 42 may be disposed vertically above the upper center console 32 of the headliner 30, between the upper center console 32 and the roof 24, because the first motor 48, the first gear set 46, the second motor 52, and the second gear set 50 are packaged tightly together within the same housing 44. The first gear set 46 and the second gear set 50 may be packaged so closely together within the same housing 44 because the first output gear 54 and the second output gear 60 are disposed adjacent opposing surfaces of the housing 44, so that the first flexible cable drive 58 may engage the first output gear 54 adjacent the first surface 66 of the housing 44, and the second flexible cable drive 64 may engage the second output gear 60 adjacent the second surface 68 of the housing 44. By positioning the sunroof transmission assembly 42 above the upper center console 32, the sunroof transmission assembly 42 is not disposed vertically above either the first passenger area 34 or the second passenger area 36, thereby allowing the headliner 30 over the first passenger area 34 and the second passenger area 36 to be positioned more closely to the roof 24, thereby increasing the head space available in the first passenger area 34 and the second passenger area 36.

FIGS. 5 and 6 show an alternative configuration of the sunroof transmission assembly 42, in which the first motor 48 and the second motor 52 are arranged to extend forward along the longitudinal axis of the vehicle 20, instead of laterally across a cross width of the vehicle 20 as shown in FIGS. 2 through 5. The sunroof transmission assembly 42 shown in FIGS. 5 and 6 operates and is otherwise configured in the same manner as described above in relation to FIGS. 2 through 4.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A sunroof transmission assembly for a vehicle, the sunroof transmission assembly comprising:
a housing;
a first gear set supported by the housing;
a first motor attached to the housing and including a first output member in meshing engagement with the first gear set;
a second gear set supported by the housing; and
a second motor attached to the housing and including a second output member in meshing engagement with the second gear set.

2. The sunroof transmission assembly set forth in claim 1 wherein the first gear set includes a first output gear, and wherein the sunroof transmission assembly further comprises a first flexible cable drive in meshing engagement with the first output gear of the first gear set, wherein the first flexible cable drive is operable to move a first sunroof component.

3. The sunroof transmission assembly set forth in claim 2 wherein the second gear set includes a second output gear, and wherein the sunroof transmission assembly further comprises a second flexible cable drive in meshing engagement with the second output gear of the second gear set, wherein the second flexible cable drive is operable to move a second sunroof component.

4. The sunroof transmission assembly set forth in claim 3 wherein the first flexible cable drive is disposed vertically above the second flexible cable drive.

5. The sunroof transmission assembly set forth in claim 4 wherein the first flexible cable drive includes an endless rotatable device having a forward loop portion contacting the first output gear in meshing engagement at a forward edge of the first output gear, and a rearward loop portion contacting the first output gear in meshing engagement at a rearward edge of the first output gear, wherein the forward edge of the first output gear and the rearward edge of the first output gear are diametrically opposed relative to each other across a diameter of the first output gear.

6. The sunroof transmission assembly set forth in claim 5 wherein the second flexible cable drive includes an endless rotatable device having a forward loop portion contacting the second output gear in meshing engagement at a forward edge of the second output gear, and a rearward loop portion contacting the second output gear in meshing engagement at a rearward edge of the second output gear, wherein the forward edge of the second output gear and the rearward edge of the second output gear are diametrically opposed relative to each other across a diameter of the second output gear.

7. The sunroof transmission assembly set forth in claim 6 wherein the forward loop portion of the first flexible cable drive is disposed vertically above the forward loop portion of the second flexible cable drive on a substantially vertical plane passing through each of the forward loop portion of the first flexible cable drive and the forward loop portion of the second flexible cable drive.

8. The sunroof transmission assembly set forth in claim 7 wherein the rearward loop portion of the first flexible cable drive is disposed vertically above the rearward loop portion of the second flexible cable drive on a substantially vertical plane passing through each of the rearward loop portion of the first flexible cable drive and the rearward loop portion of the second flexible cable drive.

9. The sunroof transmission assembly set forth in claim 4 wherein the housing includes a first surface, and an opposing second surface, and wherein the first output gear is disposed on one of the first surface and the second surface, and the second output gear is disposed on the other of the first surface and the second surface, such that the first output gear and the second output gear are disposed on opposing surfaces of the housing.

10. The sunroof transmission assembly set forth in claim 9 wherein the first gear set and the second gear set are generally disposed in a co-planar relationship relative to each other.

11. The sunroof transmission assembly set forth in claim 1 further comprising a single electrical connector attached to the housing, and disposed in electrical communication with both the first motor and the second motor.

12. The sunroof transmission assembly set forth in claim 1 wherein the first motor and the second motor are independently operable relative to each other such that the first gear set and the second gear set can be driven simultaneously.

13. The sunroof transmission assembly set forth in claim 1 wherein the housing includes a single structure supporting both the first gear set and the second gear set, and both the first motor and the second motor.

14. A vehicle comprising:
a body including a roof defining an opening;
a sunroof assembly attached to the roof of the body, adjacent to the opening, and including a first movable component, a second movable component, and a sunroof transmission assembly coupled to each of the first movable component and the second movable component, and operable to move each of the first movable component and the second movable component, wherein the sunroof transmission assembly includes:
a housing;
a first gear set supported by the housing, and including a first output gear;
a first motor attached to the housing and including a first output member in meshing engagement with the first gear set;
a first flexible cable drive in meshing engagement with the first output gear of the first gear set, wherein the first flexible cable drive is operable to move the first sunroof component in response to a rotational output from the first motor;
a second gear set supported by the housing, and including a second output gear;
a second motor attached to the housing and including a second output member in meshing engagement with the second gear set; and
a second flexible cable drive in meshing engagement with the second output gear of the second gear set, wherein the second flexible cable drive is operable to move the second sunroof component in response to a rotational output from the second motor.

15. The vehicle set forth in claim 14 further comprising a headliner disposed adjacent to the roof, and including an upper center console section disposed between a first seating area and a second seating area, wherein the sunroof transmission assembly is disposed vertically above the upper center console section of the headliner, such that the first motor, the first gear set, the second motor, and the second gear set are not disposed vertically above either the first passenger area or the second passenger area.

16. The vehicle set forth in claim 14 wherein the housing includes a first surface, and an opposing second surface, and wherein the first output gear is disposed on one of the first surface and the second surface, and the second output gear is disposed on the other of the first surface and the second surface, such that the first output gear and the second output gear are disposed on opposing surfaces of the housing.

17. The vehicle set forth in claim 14 wherein the first flexible cable drive includes an endless rotatable device having a forward loop portion contacting the first output gear in meshing engagement at a forward edge of the first output gear, and a rearward loop portion contacting the first output gear in meshing engagement at a rearward edge of the first output gear, wherein the forward edge of the first output gear and the rearward edge of the first output gear are diametrically opposed relative to each other across a diameter of the first output gear.

18. The vehicle set forth in claim 17 wherein the second flexible cable drive includes an endless rotatable device having a forward loop portion contacting the second output gear in meshing engagement at a forward edge of the second output gear, and a rearward loop portion contacting the second output gear in meshing engagement at a rearward edge of the second output gear, wherein the forward edge of the second output gear and the rearward edge of the second output gear are diametrically opposed relative to each other across a diameter of the second output gear.

19. The vehicle set forth in claim 18 wherein the forward loop portion of the first flexible cable drive is disposed vertically above the forward loop portion of the second flexible cable drive on a substantially vertical plane passing through each of the forward loop portion of the first flexible cable drive and the forward loop portion of the second flexible cable drive.

20. The vehicle set forth in claim 19 wherein the rearward loop portion of the first flexible cable drive is disposed vertically above the rearward loop portion of the second flexible cable drive on a substantially vertical plane passing through each of the rearward loop portion of the first flexible cable drive and the rearward loop portion of the second flexible cable drive.
